(19) United States
(12) Patent Application Publication
(10) Pub. No.: US 2025/0334200 A1
(43) Pub. Date: Oct. 30, 2025

(54) TRANSMITTING A PNEUMATIC SIGNAL TO AN ACTUATOR ON A VALVE

(71) Applicant: Dresser, LLC, Houston, TX (US)

(72) Inventors: Jayaganesh Nataraj, Coimbatore (IN); Arun Kumar M, Coimbatore (IN)

(21) Appl. No.: 18/644,838

(22) Filed: Apr. 24, 2024

(51) Int. Cl. F16K 31/12; F16K 31/126

(52) U.S. Cl. CPC F16K 31/12; F16K 31/1262

(57) ABSTRACT

An actuator pressuring unit is configured for use on a control valve. These configurations may include a flow path disposed in a valve stem of the valve, which terminates at an end found in the actuator. The flow path may direct a pneumatic signal from the controller to the actuator. In one implementation, the flow path has an opening outside of the actuator to receive the pneumatic signal. Other openings may reside in the actuator. These openings permit the pneumatic signal to exhaust inside of the actuator, pressurizing the actuator as necessary for use to control flow through the device.

### BACKGROUND

Flow controls play a significant role in many industrial settings. Power plants and industrial process facilities, for example, use different types of flow controls to manage flow of material, typically fluids, throughout vast networks of pipes, tanks, generators, and other equipment. Control valves are a type of flow control that operators favor to regulate flow of material on their process lines. It is common for these devices to have an actuator that requires a pneumatic input, like pressurized air. This feature, in turn, demands that the device have a designated flow path to transfer the pneumatic input throughout its structure. Many devices use tubing or hoses that wind around the outside of the structure for this purpose. However, while effective, these external parts can add unnecessary complexity and additional areas of failure to the design of the valve.

### SUMMARY

The subject matter of this disclosure relates to improvements to flow controls that eliminate the need for external flow paths for instrument air. Of particular interest are embodiments that integrate the flow path into existing structure on the device. These embodiments can accommodate operator needs for devices that have different operating modes. As noted herein, the proposed design may find use on air-to-open valves and air-to-close valves.

### DRAWINGS

This specification refers to the following drawings:

FIG. 1 depicts a schematic diagram of an embodiment of an actuator pressurizing unit;

FIG. 2 depicts a schematic diagram of an example of the actuator pressurizing unit of FIG. 1;

FIG. 3 depicts a schematic diagram of an example of the actuator pressurizing unit of FIG. 1;

FIG. 4 depicts a schematic diagram of an example of the actuator pressurizing unit of FIG. 1;

FIG. 5 depicts an elevation view of an example of the actuator pressurizing unit of FIG. 1;

FIG. 6 depicts an elevation view of an example of the actuator pressurizing unit of FIG. 1; and

FIG. 7 depicts an elevation view of details of an example of the actuator pressurizing unit of FIG. 1.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, this should not exclude plural of any such designation, unless the specification explicitly recites or explains such exclusion. Likewise, any references to “one embodiment” or “one implementation” should does not exclude the existence of additional embodiments or implementations that also incorporate the recited features.

### DESCRIPTION

The discussion now turns to describe features of the examples shown in the drawings noted above. These features equip control valves with an integral flow path to transmit instrument air throughout the device. This flow path eliminates the need for most external hoses or tubes. As noted below, the proposed design can work on different types of control valves. These types may include air-to-open valves, for example, that are held closed until instrument air increases to “open” the valve. On the other hand, air-to-close valves are held in their closed position by the instrument air. Other embodiments may be within the scope of this disclosure.

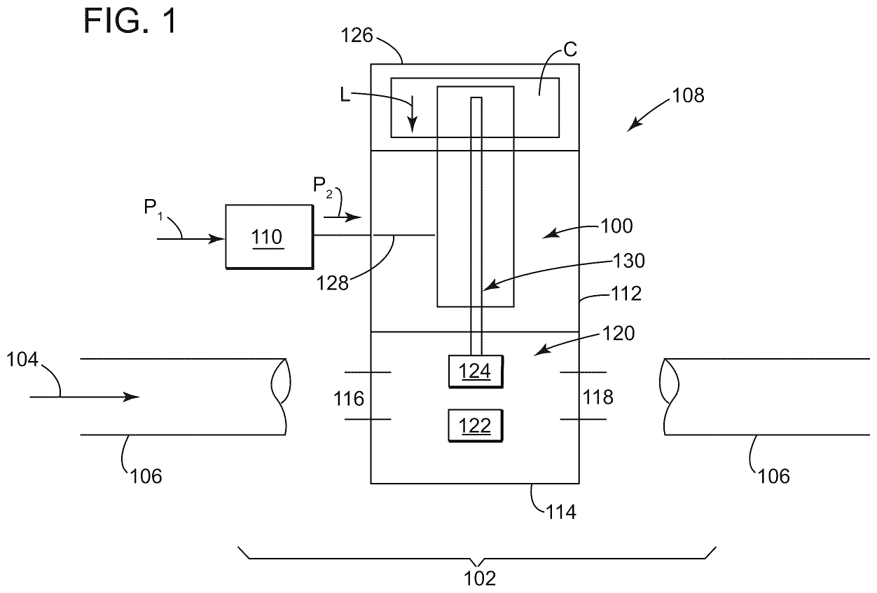

FIG. 1 depicts a schematic diagram of an exemplary embodiment of an actuator pressurizing unit 100. This embodiment is part of a distribution network 102, typically designed to carry material 104 through conduit 106. In one implementation, the actuator pressurizing unit 100 is part of a flow control 108 that may integrate into the network 102. The flow control 108 may include a controller 110 that can convert a pneumatic supply signal P₁ into an actuator control signal P₂. The controller 110 may mount to the flow control 108, for example, to its superstructure 112. As also shown, a valve body 114 with openings (e.g., an inlet 116 and an outlet 118) may reside on one side of the superstructure 112. Valve mechanics 120 may reside in the valve body 114 to regulate flow of material 104 from the inlet 116 to the outlet 118. The valve mechanics 120 may include a seat 122 and a closure member 124. An actuator 126 may reside on the other side of the superstructure 112. As shown, the actuator pressurizing unit 100 may include an actuator signal path 128 and part of a valve stem 130 that couples the closure member 124 to the actuator 126.

Broadly, the actuator pressurizing unit 100 may be configured to transmit pressurized air. These configurations may embody structure that form integral flow paths. This structure may lend itself to use on or with parts of a control valve that current designs do not leverage for this purpose. This feature is particularly beneficial because it eliminates parts from the assembly, reducing cost and complexity of the design.

The distribution system 102 may be configured to deliver or move fluids. These configurations may embody vast infrastructure. Material 104 may comprise gases, liquids, solid-liquid mixes, or liquid-gas mixes, as well. The conduit 106 may include pipes or pipelines that often connect to pumps, boilers, and the like. The pipes 106 may also connect to tanks or reservoirs. In many facilities, this equipment forms complex networks to execute a process, like refining raw materials or manufacturing a product.

The flow control 108 may be configured to regulate flow of material 104 through the conduit 106 in these complex networks. These configurations may include valves, control valves and like devices. The controller 110 may be configured to process and generate signals. These configurations may connect to a control network (or “distributed control system” or “DCS”). This network may maintain operation of all devices on process lines to ensure that materials flow in accordance with a process or meets certain process parameters. The DCS may generate control signals with operating parameters that describe or define operation of the flow control 108 for this purpose. Operating hardware in the controller 110 may employ electrical and computing components (e.g., processors, memory, executable instructions, etc.). These components may also include electro-pneumatic devices that operate on incoming pneumatic supply signal P₁, typically instrument air at process facilities. These components ensure that the outgoing actuator control signal P₂ is appropriate for the flow control 108 to supply material 104 downstream according to process parameters.

The superstructure 112 may adopt a robust, industrial design that can support components of the valve. For example, the valve body 114 in such devices is often made of cast or machined metals. This part may have flanges or another connective feature at the openings 116, 118. Adjacent pipes 106 may connect to these flanges to allow material 104 to flow into and out of the device. Preferably, the valve mechanics 120 may change an operating condition of the flow control 108 as defined, for example, by a location of the closure member 124 relative to the seat 122. This location may set appropriate flow of material 104 through the device to satisfy process requirements on the process line. Construction of components 122, 124 may allow the valve 108 to operate under extreme temperatures or pressure, as well with materials 104 that are caustic or hazardous. In one implementation, the actuator 126 may include a cavity C. The actuator control signal P₂ may pressurize the cavity C. In use, the pressure works with other components in the cavity C (like springs, diaphragms, and the like) to generate a load L on the valve stem 130. The load L may set the operating condition on the flow control 108, which in turn regulates flow of material 104 through the device to satisfy requirements on the process line.

The signal path 128 may be configured to transfer the actuator control signal P₂ from the controller 110. These configurations may integrate into the superstructure 112, for example, as machined features, attached parts, hoses or tubing, or the like. Additive manufacturing techniques (e.g., 3-D printing) may find use to manufacture the superstructure 112 with flow pathways, particularly if the designs require complex geometry.

The valve stem 130 may be configured to direct the actuator control signal P₂ from this flow pathway into the cavity C of the actuator 126. These configurations may embody an elongated member, for example, a metal rod or shaft. Its structure may have a cross-section that is round or circular; but other shapes may find use in certain applications. In one implementation, the valve stem 130 will adopt structure that can both transfer the load L from the actuator 126 to the closure member 124 and accommodate the design features that transfer or transmit pressurized air as noted herein. These design features may include internal flow pathways that will direct the actuator control signal P₂ to locations that allow for the flow control 108 to operate in different operating modes. For example, the internal flow pathways may distribute the actuator control signal P₂ in the cavity C to operate the flow control 108 in an air-to-open mode, an air-to-close mode, or in other operating modes that operators might require for their process line. Like the superstructure 112, additive manufacturing techniques (e.g., 3-D printing) may find use to manufacture the valve stem 130 with the internal flow pathways, particularly if the design requires complex geometry that is outside the bounds of traditional manufacturing techniques, like machining.

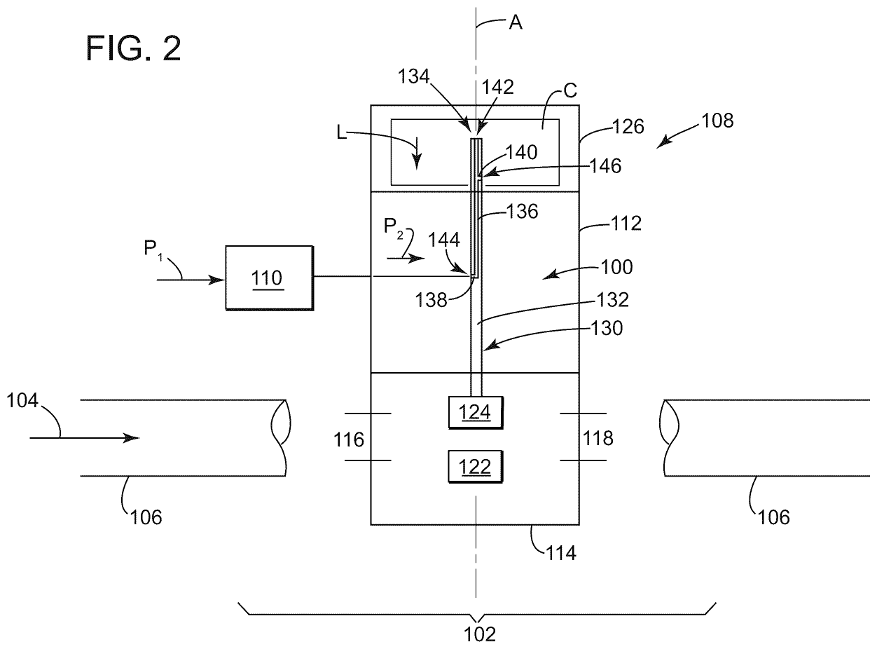

FIG. 2 depicts a schematic diagram of an example of the actuator pressurizing unit 100. The valve stem 130 may include a shaft 132 with a longitudinal axis A that extends along its length. The shaft 132 may have an end 134 that resides in the cavity C. The shaft 132 may include an internal flow pathway, shown here with a first bore 136 that extends from the end 134 lengthwise down the shaft 132 along the axis A. The internal flow pathway may also include a plurality of bores, shown here as bores 138, 140, that extend from the first bore 136, for example, in a direction that is generally perpendicular to the axis A of the shaft 132. The bores 138, 140 may reside outside and inside of the cavity C, respectively. In one implementation, the bores 136, 138, 140 may terminate at ports 142, 144, 146 that form an opening on the outer surface of the shaft 132. This opening may allow the actuator control signal P₂ to enter the internal flow pathway through port 144 and exit the internal flow pathway at either port 142 or through port 146. In one implementation, the design may include a plug that can insert into one or both of the ports 142, 146. This plug may seal or prevent flow of the actuator control signal P₂ into the cavity C of the actuator 126. The location of the plug, either at the port 142 or the port 146, may correspond with the preferred operating mode of the flow control 108.

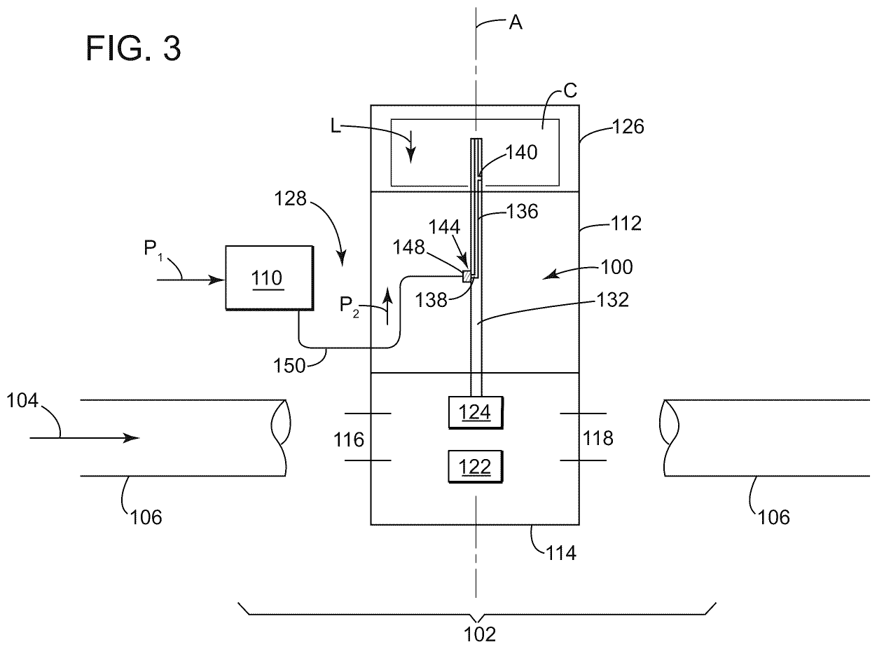

FIG. 3 depicts a schematic diagram of another example of the actuator pressurizing unit 100. A fluid coupling 148 may couple with the port 144. The fluid coupling 148 may embody a pneumatic connector, for example, with threads that match corresponding threads that populate the port 144 in the material of the shaft 132. The actuator signal path 128 may comprise a flexible hose 150 that may couple on one end to the pneumatic connector. The flexible hose 150 may embody a braided stainless-steel hose; however, this disclosure contemplates that various materials or other constructions of this part may prevail as well. The other end of the flexible hose 150 may connect to the controller 110. In use, the actuator control signal P₂ can flow from the controller 110, through the flexible hose 150, and into the internal flow pathway in the shaft 132.

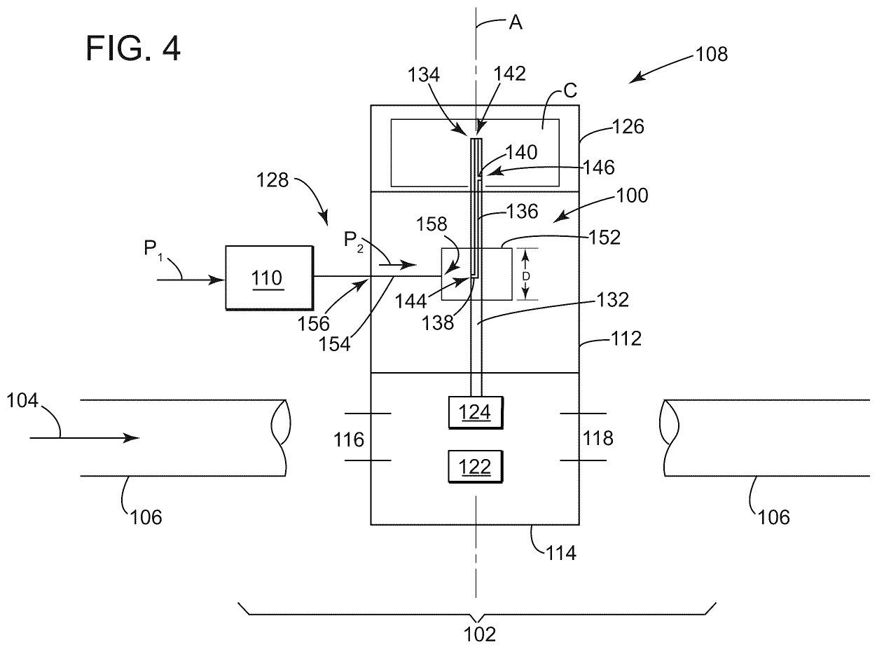

FIG. 4 depicts a schematic diagram of another example of the actuator pressurizing unit 100. The port 144 may reside in a sealed cavity 152, which may integrate into or as part of the superstructure 112. The sealed cavity 152 may circumscribe the shaft 132. Its vertical dimension D may accommodate travel of the shaft 132 in the vertical direction along the axis A. In one implementation, the actuator signal path 128 may embody a bore 154 in the superstructure 112. The bore 154 may extend between openings 156, 158, where the opening 158 provides access to the sealed cavity 152. In use, the actuator control signal P₂ can flow through the bore 154 into the sealed cavity 152, where it can enter the internal flow pathway in the shaft 132 via the port 144. The actuator control signal P₂ can flow through the internal flow pathway to exit into the cavity C in the actuator 126, either at the port 142 (at the terminal end 134 of the shaft 132) or at the port 146 at the bore 140.

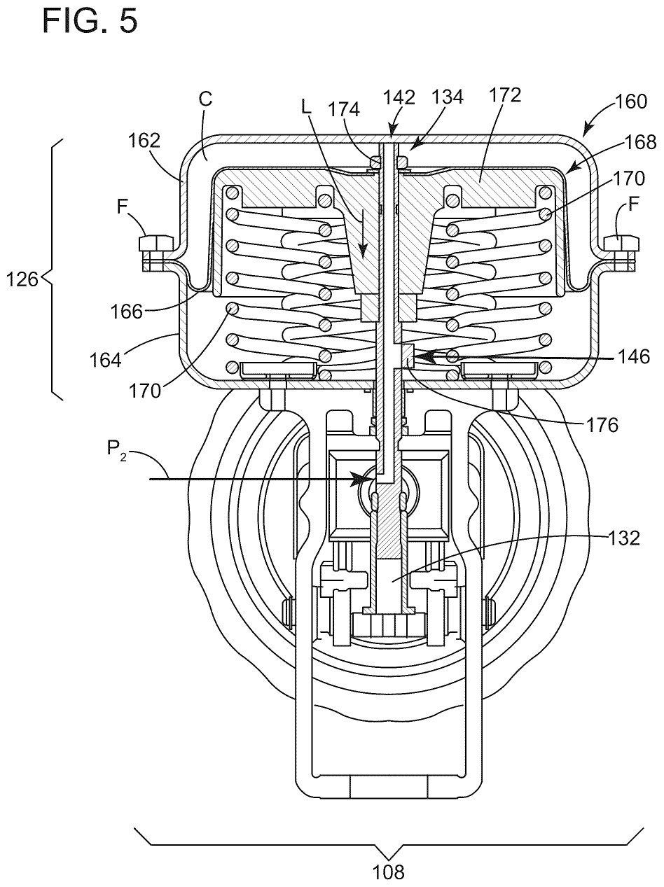

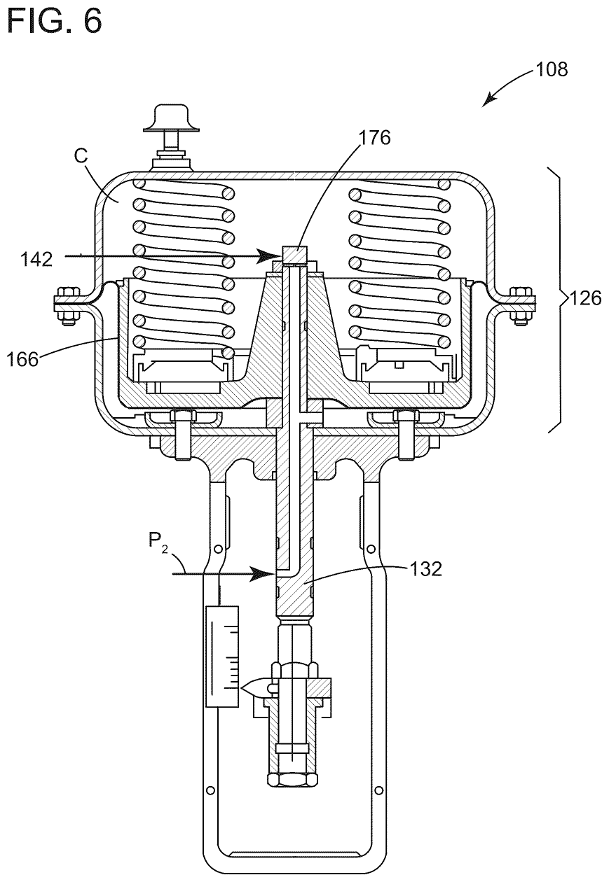

FIGS. 5 and 6 depict elevation views of the cross-section of exemplary structure of the flow control 108. The actuator 126 may have a bulbous enclosure 160 that may comprise two pieces 162, 164. Fasteners F may clamp the pieces 162, 164 about their edges to seal the enclosure 160. This arrangement may entrap a diaphragm 166 around its periphery. A piston assembly 168 may also reside inside of the sealed enclosure 160. The piston assembly 168 may include springs 170 and a piston 172. The shaft 132 may attach to the piston 172, for example, by threading a nut 174 onto the end 134. In use, deflection of the springs 170 may generate a spring load that, together with internal pressure due to the actuator control signal P₂, regulates the location of the closure member 124 relative to the seat 122 (FIG. 1). Notably, the arrangement of the actuator 126 may locate the ports 142, 146 of the shaft 132 on opposite sides of the diaphragm 166. A plug 176 may reside in the port 146. This arrangement permits the actuator control signal P₂ to pressurize a first side of the diaphragm 166, which might occur on an air-to-close device. As best shown in FIG. 6, the plug 176 may reside in the port 142. This arrangement permits the actuator control signal P₂ to pressurize a second side of the diaphragm 166, which might occur on an air-to-open device.

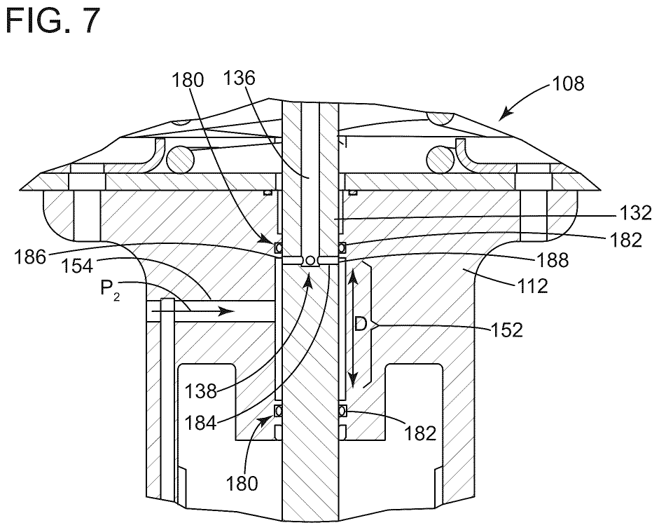

FIG. 7 depicts an elevation view in detail of the cross-section of exemplary structure of the flow control 108. The device may include annular grooves 180 that can receive O-rings 182, which may contact the shaft 132. This arrangement may seal the sealed cavity 152 to prevent leaks of actuator control signal P₂ that enters through the bore 154. The bore 138 may embody a through-hole 184, which penetrates the shaft 132 to form diametrically opposed openings 186, 188. As noted, dimension D (or the height of the sealed cavity 152) allows for the through-bore 184 to travel vertically between the O-rings 182. In one implementation, the dimension D is around 2.5 in (64 mm).

Considering the foregoing, the improvements herein simplify the design of control valves. This design utilizes existing hardware, namely, the valve stem, to direct pressurized air for use at the pneumatic actuator of control valves. In this way, the design eliminates the need for external hoses or tubes, which can reduce costs of the assembly, shrink the footprint of the device, and lower operating risks associated with use of external hoses and tubes.

This specification may include and contemplate other examples that occur to those skilled in the art. These other examples fall within the scope of the claims, for example, if they have structural elements that do not differ from the literal language of the claims, or if they include equivalent structural elements with insubstantial differences from the literal language of the claims.

What is claimed is:

1. A valve, comprising:
a pneumatic actuator;
a valve stem coupled to the actuator; and
a controller,
wherein the valve stem is configured to direct a pneumatic signal from the controller into the pneumatic actuator.

2. The valve of claim 1, wherein the valve stem comprises at least one internal flow pathway.

3. The valve of claim 1, wherein the valve stem comprises at least one internal flow pathway that has a bore extending along the length of the valve stem.

4. The valve of claim 1, wherein the valve stem comprises at least one internal flow pathway that has a first bore extending along the length of the valve stem and a second bore extending perpendicular to the first bore.

5. A valve, comprising:
a pneumatic actuator;
superstructure having a first side coupled with the pneumatic actuator; and
a valve stem coupled to the superstructure, the valve stem comprising a first end and a second end, the first end couple with the actuator and the second end coupled with the valve, the valve stem having an internal flow pathway that extends from a first port inside of the actuator to a second port disposed outside of the actuator.

6. The valve of claim 5, wherein the internal flow pathway comprises at least a third port that resides inside of the actuator.

7. The valve of claim 5, further comprising:
a plug disposed in the first port.

8. The valve of claim 5, further comprising:
a plug disposed in a third port of the internal flow pathway that resides inside of the actuator.

9. The valve of claim 5, further comprising:
a pneumatic connector coupled to the second port.

10. The valve of claim 5, further comprising:
a pneumatic connector coupled to the second port; and
a flexible hose coupled to the pneumatic connector.

11. The valve of claim 5, further comprising:
a controller mounted to the superstructure, the controller having operating hardware to convert an incoming pneumatic signal into an outgoing pneumatic signal; and
a flexible hose coupled to the controller and to the second port on the valve stem to create a signal pathway that directs the outgoing pneumatic signal from the controller to the internal flow pathway in the valve stem.

12. The valve of claim 5, further comprising:
a controller mounted to the superstructure, the controller having operating hardware to convert an incoming pneumatic signal into an outgoing pneumatic signal,
wherein the superstructure is configured to direct the outgoing pneumatic signal from the controller to the internal flow pathway of the valve stem.

13. The valve of claim 5, further comprising:
a controller mounted to the superstructure, the controller having operating hardware to convert an incoming pneumatic signal into an outgoing pneumatic signal; and
a signal pathway coupled to the controller and to the internal flow pathway of the valve stem,
wherein the signal pathway is configured to direct the outgoing pneumatic signal from the controller o the internal flow pathway of the valve stem.

14. The valve of claim 5, wherein the superstructure forms a sealed cavity around a portion of the valve stem that includes the second port.

15. A valve, comprising:
a pneumatic actuator;
a valve stem having a first end, a second end, and an axis extending therebetween, the first end residing inside of the pneumatic actuator, the valve stem forming at least one internal flow pathway with,
a first bore extending from the first end along the axis; and
a second bore extending from the first bore perpendicularly to the axis;
a signal pathway coupled to the second bore; and
a controller coupled to the signal pathway, the controller having operating hardware to convert an incoming pneumatic signal into an outgoing pneumatic signal.

16. The valve of claim 15, wherein the signal pathway comprises a flexible hose that couples the controller to the second bore.

17. The valve of claim 15, wherein the signal pathway comprises a pneumatic connector coupled to the valve stem and a flexible hose coupled to the pneumatic connector and the controller.

18. The valve of claim 15, further comprising:
a superstructure having a first end and a second end, the first end coupled to the pneumatic actuator,
wherein the signal pathway comprises a bore integral to the superstructure.

19. The valve of claim 15, further comprising:
a superstructure having a first end and a second end, the first end coupled to the pneumatic actuator, the superstructure forming a cavity around part of the valve stem;
wherein the signal pathway comprises a bore integral to the superstructure that terminates at the cavity.

20. The valve of claim 15, further comprising:
a superstructure having a first end and a second end, the first end coupled to the pneumatic actuator, the superstructure forming a cavity around part of the valve stem;
o-rings disposed on opposing sides of the cavity, the o-rings contacting the valve stem,
wherein the signal pathway comprises a bore integral to the superstructure that terminates at the cavity.
